(19) United States
(12) Patent Application Publication
(10) Pub. No.: US 2004/0243801 A1
(43) Pub. Date: Dec. 2, 2004

(54) Trusted device

(76) Inventors: Liqun Chen, Bristol (GB); Clavin Lap Kei Lee, London (GB)

Correspondence Address: Hewlett-Packard Company, Intellectual Property Administration, P O Box 272400, Fort Collins, CO, 80527-2400, US

(21) Appl. No.: 10/344,062

(22) PCT Filed: Aug. 16, 2001
(86) PCT No.: PCT/GB01/03667

(30) Foreign Application Priority Data
Aug. 18, 2000 (GB) 0020370.3

(51) Int. Cl. H04L 9/00; G09G 5/00

(52) U.S. Cl. 713/160; 345/864

(57) ABSTRACT

A portable handheld computing apparatus comprising acquiring means for acquiring an first integrity metric of a first computer apparatus for determining if the first computer apparatus is a trusted entity, the acquiring means being responsive to input means for initiating the acquisition; and presentation means for presenting to a user an indication that the first computer apparatus is a trusted device.

### BACKGROUND ART

For commercial applications, a client computing platform typically operates in an environment where its behaviour is vulnerable to modification by local or remote entities. This potential insecurity of the platform is a limitation on its use by local parties who might otherwise be willing to use the platform, or remote parties who might otherwise communicate with the platform; for example, for the purposes of E-commerce.

Existing security applications, for example virus detection software, execute on computing platforms under the assumption that the platform will operate as intended and that the platform will not subvert processes and applications. This is a valid assumption provided that the intended software state has not become unstable or has not been damaged by other software such as viruses. Users, therefore, typically restrict the use of such platforms to non-critical applications, and weigh the convenience of using the platforms against the risk to sensitive or business critical data.

Increasing the level of trust in platforms therefore enables greater user confidence in existing security applications (such as the ‘Secure Sockets Layer’ or ‘IPSec’) or remote management applications. This enables greater reliance on those applications and hence reduced ‘cost of ownership’. Greater trust also enables new electronic methods of business, since there is greater confidence in the correct operation of both local and remote computing platforms.

EP patent application Ser. No. 99301100.6 discloses the incorporation into a computing platform of a physical trusted device whose function is to bind the identity of the platform to reliably measured data that provides an integrity metric of the platform. The identity and the integrity metric are compared with expected values provided by a trusted party (TP) that is prepared to vouch for the trustworthiness of the platform. If there is a match, the implication is that at least part of the platform is operating correctly, depending on the scope of the integrity metric.

A user verifies the correct operation of the platform before exchanging other data with the platform. A user does this by requesting the trusted device to provide its identity and an integrity metric. (Optionally the trusted device will refuse to provide evidence of identity if it itself was unable to verify correct operation of the platform.) The user receives the proof of identity and the identity metric, and compares them against values which it believes to be true. Those proper values are provided by the TP or another entity that is trusted by the user. If data reported by the trusted device is the same as that provided by the TP, the user trusts the platform. This is because the user trusts the entity. The entity trusts the platform because it has previously validated the identity and determined the proper integrity metric of the platform.

Once a user has established trusted operation of the platform, he exchanges other data with the platform. For a local user, the exchange might be by interacting with some software application running on the platform. For a remote user, the exchange might involve a secure transaction. In either case, the data exchanged is ‘signed’ by the trusted device. The user can then have greater confidence that data is being exchanged with a platform whose behaviour can be trusted.

However a remote user can not guarantee that the response from the apparatus is verified in a trusted manner.

It is desirable to improve this situation.

In this document, the word ‘trust’ is used in the sense that something can be ‘trusted’ if it always behaves in the expected manner for the intended purpose.

### SUMMARY OF THE INVENTION

In accordance with a first aspect of the present invention there is provided a portable handheld computing apparatus comprising acquiring means for acquiring an first integrity metric of a first computer apparatus for determining if the first computer apparatus is a trusted entity, the acquiring means being responsive to input means for initiating the acquisition; and presentation means for presenting to a user an indication that the first computer apparatus is a trusted device.

Preferably the portable handheld computing apparatus further comprising a trusted device being arranged to acquire an second integrity metric for the portable handheld computing apparatus to allow determination as to whether the portable handheld computing apparatus is a trusted entity; and communication means for communicating the second integrity metric to the first computer apparatus to allow mutual determination as to the trusted state of the portable handheld computer apparatus and first computer apparatus.

Optionally the portable handheld computer apparatus further comprising cryptographic means arranged to provide authentication data to the first computer apparatus.

The present invention relates to apparatus and methods to enhance trust and confidence of the user by checking the integrity of an apparatus using a Portable Security Challenger. A Portable Security Challenger can be a personal digital assistant, a mobile phone, a smart card or a biometrics reader. A Portable Security Challenger is used to challenge a trusted device in order to get the Integrity Matrix from the Trusted Device, the Portable Security Challenger can also be used to authenticate its users. A Portable Security Challenger might not be a dedicated challenging device, any device with computing power, user interface and communication media could possibly be turned into a Portable Security Challenger.

This invention extends the prior art method of integrity checking of the computing apparatus, and allows the user to use a trusted portable challenger with powerful user interface to challenge the apparatus. A portable security challenger with powerful user interface allows a users trust and confidence in integrity checking of the computing apparatus to be enhanced.

In the present invention a mutual integrity challenge is defined. Further exchange session key is provided for further secure communication.

The present invention seeks to provide apparatus for challenging computing apparatus and verify the response sent from the computing apparatus and to show the user a trusted result.

Preferably the portable handheld computing apparatus can perform functions other than integrity checking, and it is able to isolate the other functions while doing integrity check process. All the data and processes of the integrity checking are protected, the other functions, processes or programs in such a challenger should not interfere with any part of the integrity checking process.

Preferably the apparatus is a personal digital assistant (PDA) device or trusted PDA device. A trusted PDA is an ordinary PDA with a physically bounded trusted device. It can make self-integrity checking and the user can trust the result of the self-integrity checking. Optionally, a trusted PDA is an ordinary PDA with a smart card, which is able to check the integrity of the PDA and result of the integrity checking can be displayed and can be trusted by the user.

Preferably the apparatus is a mobile phone or trusted mobile phone. A trusted mobile phone is an ordinary mobile phone with a physically bounded trusted device. It can make self-integrity checking and the result of the self-integrity checking is trusted by the user. Optionally, a trusted mobile phone is an ordinary mobile phone with a smart card, which is able to check integrity of the mobile phone and result of the integrity checking can be displayed and can be trusted by the user.

Preferably the apparatus is a smart card with self-display function.

Preferably the apparatus is a biometrics reader with self-display function. A trusted biometrics reader is an ordinary biometrics reader with a physically bounded trusted device. It can make self-integrity checking and the result of the self-integrity checking can be displayed and can be trusted by the user.

### BRIEF DESCRIPTION OF THE DRAWINGS

Preferred embodiments of the present invention will now be described, by way of example only, with reference to the accompanying drawings, of which:

FIG. 1 is a diagram that illustrates a system capable of implementing embodiments of the present invention;

FIG. 2 is a diagram which illustrates a motherboard including a trusted device arranged to communicate with a smart card via a smart card reader and with a group of modules;

FIG. 3 is a diagram that illustrates the trusted device in more detail;

FIG. 4 is a flow diagram which illustrates the steps involved in acquiring an integrity metric of the computing apparatus;

FIG. 5 illustrates mutual integrity checking using a portable security challenger;

FIG. 6 illustrates mutual integrity checking between a portable security challenger and a trusted device has a public/private key pair;

FIG. 7 illustrates mutual integrity checking between a computing apparatus (trusted device) and a trusted portable security challenger;

FIG. 8 illustrates an example for the protocol between the computing apparatus (trusted device) and a portable security challenger when using a shared secret key;

FIG. 9 illustrates mutual integrity checking between a computing apparatus (trusted device) and a trusted portable security challenger when using a shared secret key;

FIG. 10 illustrates an example for the protocol between a computing apparatus (trusted device) and a trusted portable security challenger when there is no need to authenticate the user.

### DETAILED DESCRIPTION OF THE INVENTION

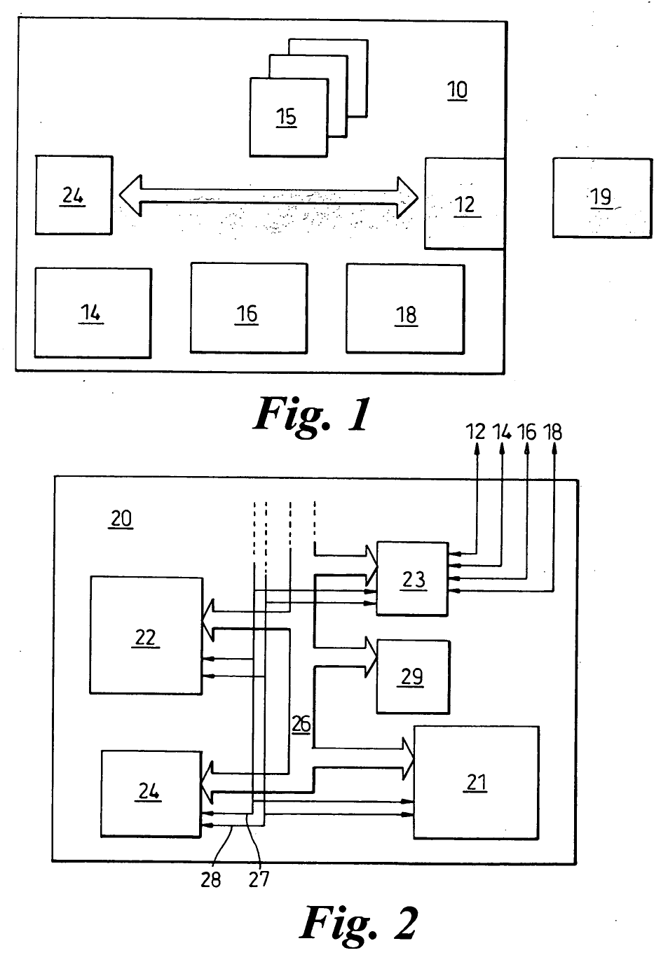

A trusted platform 10 is illustrated in the diagram in FIG. 1. The platform 10 includes the standard features of a keyboard 14, mouse 16 and visual display unit (VDU) 18, which provide the physical ‘user interface’ of the platform. This embodiment of a trusted platform also contains a smart card reader 12—a smart card reader is not an essential element of all trusted platforms, but is employed in various preferred embodiments described below. Along side the smart card reader 12, there is illustrated a smart card 19 to allow trusted user interaction with the trusted platform as shall be described further below. In the platform 10, there are a plurality of modules 15: these are other functional elements of the trusted platform of essentially any kind appropriate to that platform (the functional significance of such elements is not relevant to the present invention and will not be discussed further herein).

As illustrated in FIG. 2, the motherboard 20 of the trusted computing platform 10 includes (among other standard components) a main processor 21, main memory 22, a trusted device 24, a data bus 26 and respective control lines 27 and lines 28, BIOS memory 29 containing the BIOS program for the platform 10 and an Input/Output (IO) device 23, which controls interaction between the components of the motherboard and the smart card reader 12, the keyboard 14, the mouse 16 and the VDU 18. The main memory 22 is typically random access memory (RAM). In operation, the platform 10 loads the operating system, for example Windows NT™, into RAM from hard disk (not shown). Additionally, in operation, the platform 10 loads the processes or applications that may be executed by the platform 10 into RAM from hard disk (not shown).

Typically, in a personal computer the BIOS program is located in a special reserved memory area, the upper 64K of the first megabyte do the system memory (addresses FØØØh to FFFFh), and the main processor is arranged to look at this memory location first, in accordance with an industry wide standard.

The significant difference between the platform and a conventional platform is that, after reset, the main processor is initially controlled by the trusted device, which then hands control over to the platform-specific BIOS program, which in turn initialises all input/output devices as normal. After the BIOS program has executed, control is handed over as normal by the BIOS program to an operating system program, such as Windows NT (TM), which is typically loaded into main memory 22 from a hard disk drive (not shown).

Clearly, this change from the normal procedure requires a modification to the implementation of the industry standard, whereby the main processor 21 is directed to address the trusted device 24 to receive its first instructions. This change may be made simply by hard-coding a different address into the main processor 21. Alternatively, the trusted device 24 may be assigned the standard BIOS program address, in which case there is no need to modify the main processor configuration.

It is highly desirable for the BIOS boot block to be contained within the trusted device 24. This prevents subversion of the obtaining of the integrity metric (IM) (which could otherwise occur if rogue software processes are present) and prevents rogue software processes creating a situation in which the BIOS (even if correct) fails to build the proper environment for the operating system. Although, in the preferred embodiment to be described, the trusted device 24 is a single, discrete component, it is envisaged that the functions of the trusted device 24 may alternatively be split into multiple devices on the motherboard, or even integrated into one or more of the existing standard devices of the platform. For example, it is feasible to integrate one or more of the functions of the trusted device into the main processor itself, provided that the functions and their communications cannot be subverted. This, however, would probably require separate leads on the processor for sole use by the trusted functions. Additionally or alternatively, although in the present embodiment the trusted device is a hardware device that is adapted for integration into the motherboard 20, it is anticipated that a trusted device may be implemented as a ‘removable’ device, such as a dongle, which could be attached to a platform when required. Whether the trusted device is integrated or removable is a matter of design choice. However, where the trusted device is separable, a mechanism for providing a logical binding between the trusted device and the platform should be present.

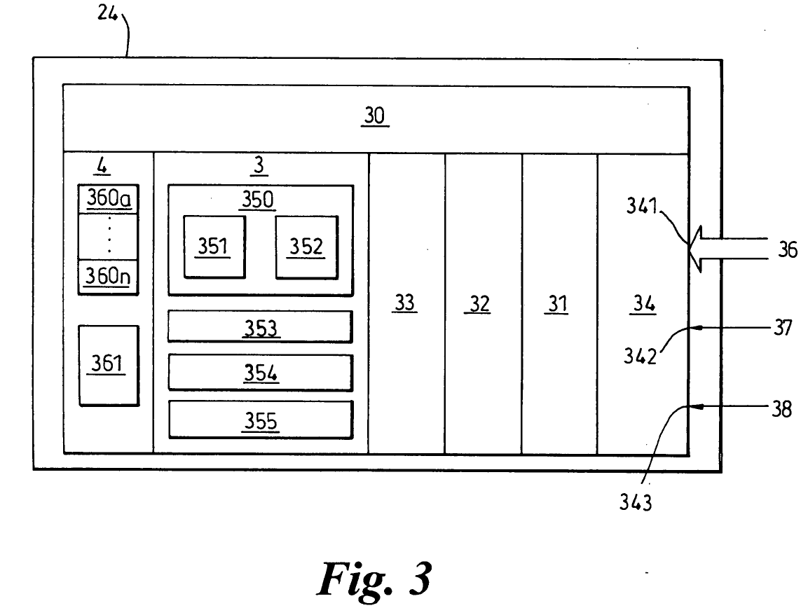

The trusted device 24 comprises a number of blocks, as illustrated in FIG. 3. After system reset, the trusted device 24 performs a secure boot process to ensure that the operating system of the platform 10 (including the system clock and the display on the monitor) is running properly and in a secure manner. During the secure boot process, the trusted device 24 acquires an integrity metric of the computing platform 10. The trusted device 24 can also perform secure data transfer and, for example, authentication between it and a smart card via encryption/decryption and signature/verification. The trusted device 24 can also securely enforce various security control policies, such as locking of the user interface.

Specifically, the trusted device comprises: a controller 30 programmed to control the overall operation of the trusted device 24, and interact with the other functions on the trusted device 24 and with the other devices on the motherboard 20; a measurement function 31 for acquiring the integrity metric from the platform 10; a cryptographic function 32 for signing, encrypting or decrypting specified data; an authentication function 33 for authenticating a smart card; and interface circuitry 34 having appropriate ports (36, 37 & 38) for connecting the trusted device 24 respectively to the data bus 26, control lines 27 and address lines 28 of the motherboard 20. Each of the blocks in the trusted device 24 has access (typically via the controller 30) to appropriate volatile memory areas 4 and/or non-volatile memory areas 3 of the trusted device 24. Additionally, the trusted device 24 is designed, in a known manner, to be tamper resistant.

For reasons of performance, the trusted device 24 may be implemented as an application specific integrated circuit (ASIC). However, for flexibility, the trusted device 24 is preferably an appropriately programmed micro-controller. Both ASICs and micro-controllers are well known in the art of microelectronics and will not be considered herein in any further detail.

One item of data stored in the non-volatile memory 3 of the trusted device 24 is a certificate 350. The certificate 350 contains at least a public key 351 of the trusted device 24 and an authenticated value 352 of the platform integrity metric measured by a trusted party (TP). The certificate 350 is signed by the TP using the TP's private key prior to it being stored in the trusted device 24. In later communications sessions, a user of the platform 10 can verify the integrity of the platform 10 by comparing the acquired integrity metric with the authentic integrity metric 352. If there is a match, the user can be confident that the platform 10 has not been subverted. Knowledge of the TP's generally-available public key enables simple verification of the certificate 350. The non-volatile memory 35 also contains an identity (ID) label 353. The ID label 353 is a conventional ID label, for example a serial number, that is unique within some context. The ID label 353 is generally used for indexing and labelling of data relevant to the trusted device 24, but is insufficient in itself to prove the identity of the platform 10 under trusted conditions.

The trusted device 24 is equipped with at least one method of reliably measuring or acquiring the integrity metric of the computing platform 10 with which it is associated. In the present embodiment, the integrity metric is acquired by the measurement function 31 by generating a digest of the BIOS instructions in the BIOS memory. Such an acquired integrity metric, if verified as described above, gives a potential user of the platform 10 a high level of confidence that the platform 10 has not been subverted at a hardware, or BIOS program, level. Other known processes, for example virus checkers, will typically be in place to check that the operating system and application program code has not been subverted.

The measurement function 31 has access to: non-volatile memory 3 for storing a hash program 354 and a private key 355 of the trusted device 24, and volatile memory 4 for storing acquired integrity metric in the form of a digest 361. In appropriate embodiments, the volatile memory 4 may also be used to store the public keys and associated ID labels 360a-360n of one or more authentic smart cards 19s that can be used to gain access to the platform 10.

In one preferred implementation, as well as the digest, the integrity metric includes a Boolean value, which is stored in volatile memory 4 by the measurement function 31, for reasons that will become apparent.

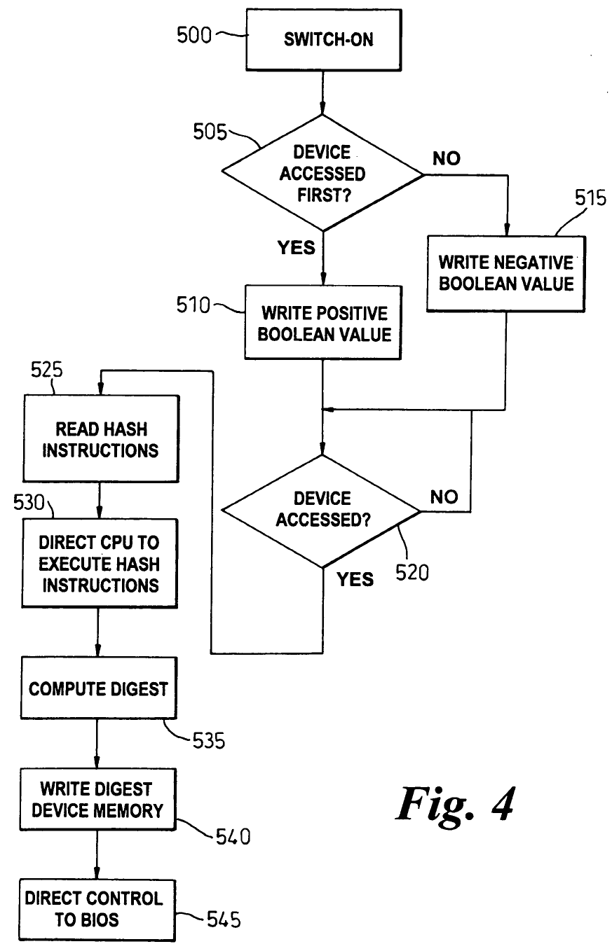

A preferred process for acquiring an integrity metric will now be described with reference to FIG. 4.

In step 500, at switch-on, the measurement function 31 monitors the activity of the main processor 21 on the data, control and address lines (26, 27 & 28) to determine whether the trusted device 24 is the first memory accessed. Under conventional operation, a main processor would first be directed to the BIOS memory first in order to execute the BIOS program. However, in accordance with the present embodiment, the main processor 21 is directed to the trusted device 24, which acts as a memory. In step 505, if the trusted device 24 is the first memory accessed, in step 510, the measurement function 31 writes to volatile memory 3 a Boolean value which indicates that the trusted device 24 was the first memory accessed. Otherwise, in step 515, the measurement function writes a Boolean value which indicates that the trusted device 24 was not the first memory accessed.

In the event the trusted device 24 is not the first accessed, there is of course a chance that the trusted device 24 will not be accessed at all. This would be the case, for example, if the main processor 21 were manipulated to run the BIOS program first. Under these circumstances, the platform would operate, but would be unable to verify its integrity on demand, since the integrity metric would not be available. Further, if the trusted device 24 were accessed after the BIOS program had been accessed, the Boolean value would clearly indicate lack of integrity of the platform.

In step 520, when (or if) accessed as a memory by the main processor 21, the main processor 21 reads the stored native hash instructions 354 from the measurement function 31 in step 525. The hash instructions 354 are passed for processing by the main processor 21 over the data bus 26. In step 530, main processor 21 executes the hash instructions 354 and uses them, in step 535, to compute a digest of the BIOS memory 29, by reading the contents of the BIOS memory 29 and processing those contents according to the hash program. In step 540, the main processor 21 writes the computed digest 361 to the appropriate non-volatile memory location 4 in the trusted device 24. The measurement function 31, in step 545, then calls the BIOS program in the BIOS memory 29, and execution continues in a conventional manner.

Clearly, there are a number of different ways in which the integrity metric may be calculated, depending upon the scope of the trust required. The measurement of the BIOS program's integrity provides a fundamental check on the integrity of a platform's underlying processing environment. The integrity metric should be of such a form that it will enable reasoning about the validity of the boot process—the value of the integrity metric can be used to verify whether the platform booted using the correct BIOS. Optionally, individual functional blocks within the BIOS could have their own digest values, with an ensemble BIOS digest being a digest of these individual digests. This enables a policy to state which parts of BIOS operation are critical for an intended purpose, and which are irrelevant (in which case the individual digests must be stored in such a manner that validity of operation under the policy can be established).

Other integrity checks could involve establishing that various other devices, components or apparatus attached to the platform are present and in correct working order. In one example, the BIOS programs associated with a SCSI controller could be verified to ensure communications with peripheral equipment could be trusted. In another example, the integrity of other devices, for example memory devices or co-processors, on the platform could be verified by enacting fixed challenge/response interactions to ensure consistent results. Where the trusted device 24 is a separable component, some such form of interaction is desirable to provide an appropriate logical binding between the trusted device 14 and the platform. Also, although in the present embodiment the trusted device 24 utilises the data bus as its main means of communication with other parts of the platform, it would be feasible, although not so convenient, to provide alternative communications paths, such as hard-wired paths or optical paths. Further, although in the present embodiment the trusted device 24 instructs the main processor 21 to calculate the integrity metric in other embodiments, the trusted device itself is arranged to measure one or more integrity metrics.

Preferably, the BIOS boot process includes mechanisms to verify the integrity of the boot process itself. Such mechanisms are already known from, for example, Intel's draft “Wired for Management baseline specification v 2.0-BOOT Integrity Service”, and involve calculating digests of software or firmware before loading that software or firmware. Such a computed digest is compared with a value stored in a certificate provided by a trusted entity, whose public key is known to the BIOS. The software/firmware is then loaded only if the computed value matches the expected value from the certificate, and the certificate has been proven valid by use of the trusted entity's public key. Otherwise, an appropriate exception handling routine is invoked.

Optionally, after receiving the computed BIOS digest, the trusted device 24 may inspect the proper value of the BIOS digest in the certificate and not pass control to the BIOS if the computed digest does not match the proper value. Additionally, or alternatively, the trusted device 24 may inspect the Boolean value and not pass control back to the BIOS if the trusted device 24 was not the first memory accessed. In either of these cases, an appropriate exception handling routine may be invoked.

Turning now to a remote portable security challenger (PSC) that allows a user to verify the trusted platform 10 in a trusted manner. The PSC can be a personal digital assistant (PDA), a mobile phone, a smart card or a biometrics reader. A PSC need not be a dedicated challenging device; the PSC can have additional functionality other than integrity checking. Any device with reasonable computing power, user interface, with a display for display a TD integrity metric, and communication media could be turned into a PSC, however it is desirable that the PSC includes tamper proved storage for:

Shared key or Public/Private key pair

PIN to protect data in the PSC

Optional Key pair for other services (e.g. payment using TD)

The PSC should preferably have the following properties:

The sensitive data (e.g. private key) should be stored in a tamper proved memory or protected memory with restricted access.

The sensitive data can only be used by authorised people (e.g. protected by passwords).

The sensitive data cannot be disclosed, changed, deleted or copied by other functions, programs or processes inside the PSC.

Other functions, processes, or programs in the PSC cannot interfere with the integrity checking process.

A PSC is used to challenge the trusted platform 10, containing trusted device 24 in order to get the IM from the trusted device 24 for the trusted platform 10. Additionally, the PSC can also be used to authenticate the users of the PSC and the trusted platform 10.

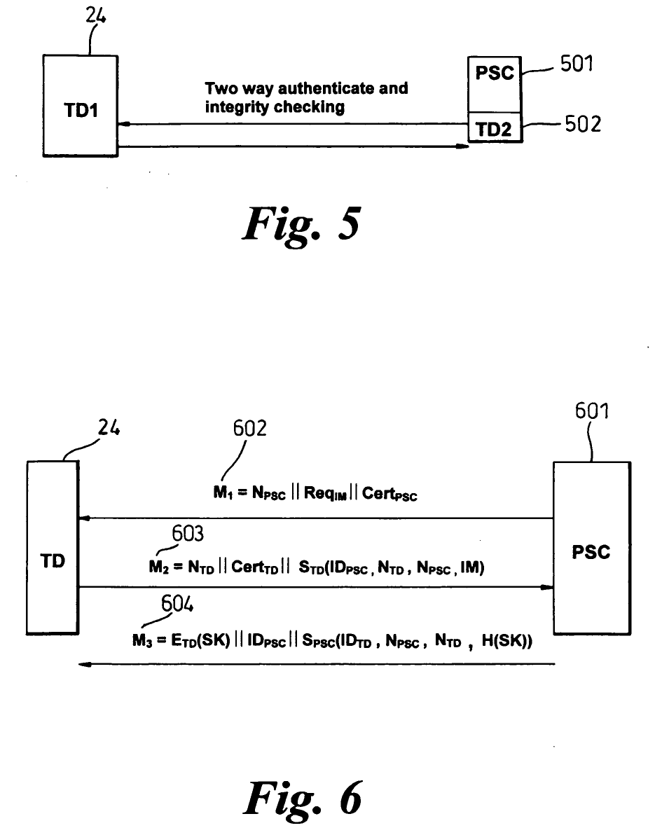

FIG. 5 illustrates two way authentication and integrity checking between the trusted device 24 and a PSC 501 containing a trusted device 502.

Two options available for user authentication are PST with private/public key pair and PST has a symmetric shared key with TD.

A good key management scheme is very important for both options, for example there should be procedures to follow when generate keys, revoke keys, destroy keys etc.

For the first option, a private/public key pair has to be installed. The TD 502 installed in the PSC 501 allows the key pair that is installed in the TD 502 to be used. Another advantage of using the TD 502 is that it provides tamper proofing.

However it is not compulsory to install a TD in the PSC, if the PSC can store the keys in a secure memory and perform the authentication and integrity checks. But with the TD installed, the integrity of the PSC can also be checked.

The challenge (i.e. initiating a request for the TD IM and/or authentication of a user) can be done through a network or internet, so authentication of the PSC 501 (and optionally authentication of the TD 24 in the trusted platform 10) has to be done with a secure protocol, the level of security depending on the application. After the PSC 501 and the TD 24 have authenticated each other, the TD 24 should send its IM to PSC 501. Then the user of the PSC 501 can decide whether to trust the TD 24 and use services on the TD 24.

One advantage of using the first option (Private/Public key) is it can easily be integrated into any existing Public Key Infrastructure (PKI). The Public and Private keys can then be used to provide a secure communication channel (encryption and signature) and authentication between TD 24 and PSC 501 (with/without TD). Note that not all applications need to use encryption and signatures, but the users can decide whether to use them or not. The protocols can provide optional encryption and signature capabilities.

FIG. 6 illustrates a protocol used to allow the PSC 601 to challenge TD 24, of the trusted platform 10, to obtain the TD's IM. This protocol uses a public/private key pair for encryption and signature. A session key (SK) is optional for further communication. The protocol uses the following information:

N_{PSC}=Nonce (Random number) generated by PSC

N_{TD}=Nonce generated by TD

N_{TD2}=Nonce generated by TD2

Req_{IM}=Request for the Integrity Matrix of TD

Req_{IM2}=Request for the Integrity Matrix of TD2

E_{PSC}=Encrypt using PSC's public key

E_{TD}=Encrypt using TD's public key

E_{TD2}=Encrypt using TD2's public key

S_{PSC}=Sign using PSC's private key

S_{TD}=Sign using TD's private key

S_{TD2}=Sign using TD2's private key

Cert_{PSC}=Certificate of PSC, hence public key of PSC

Cert_{TD}=Certificate of TD, hence public key of TD

Cert_{TD2}=Certificate of TD2, hence public key of TD2

ID_{PSC}=Identity/Name of PSC

ID_{TD}=Identity/Name of TD

ID_{TD2}=Identity/Name of TD2

SK=Optional session key

H=Hash

HMAC=Hash Message Authentication Code

E_{S}=Encryption using the shared key

Key=Shared Key

A first message M1 601 is transmitted from the PSC 601 to the TD 24. The first message M1 602 includes the following data N_{PSC}, Req_{IM}, and Cert_{PSC}. In response to the first message M1 602 the TD 24 transmits a second message M2 603 to the PSC 601. The second message M2 603 includes the following data N_{TD}, Cert_{TD} and the following signed using the TD's private key—ID_{PSC} N_{TD} N_{PSC} IM. In response to the second message M2 603 the PSC 601 transmits a third message M3 604 to the TD 24. The third message M3 604 includes the following data ID_{PSC} and the following signed using the PSC's private key—ID_{TD} N_{PSC} N_{TD}. Optionally message M3 604 can included SK that is encrypted using the TD public key and a hash of the SK that has been signed using the PSC's private key.

This protocol allows the PSC 601 to obtain a trusted response from the TD 24, and to authenticate the user of the PSC 601 to the TD 24. Nothing needs to be kept secret (apart form the optional SK) so there is no need to encrypt M₁ 602 and M₂ 603. But if the communicators want to keep their communications confidential from other parties, they can use encryption.

It is assumed that TD 24 can verify public keys via a trusted CA (not shown). The certificates can then provide the authenticity of the public keys that can be used to verify signatures. The public and private key pairs of the TD 24 should not be the Endorsement (Master) key pairs, it should be a key pair created by the owner of the TD 24. The reason is the user can revoke a key pair if the private key is compromised.

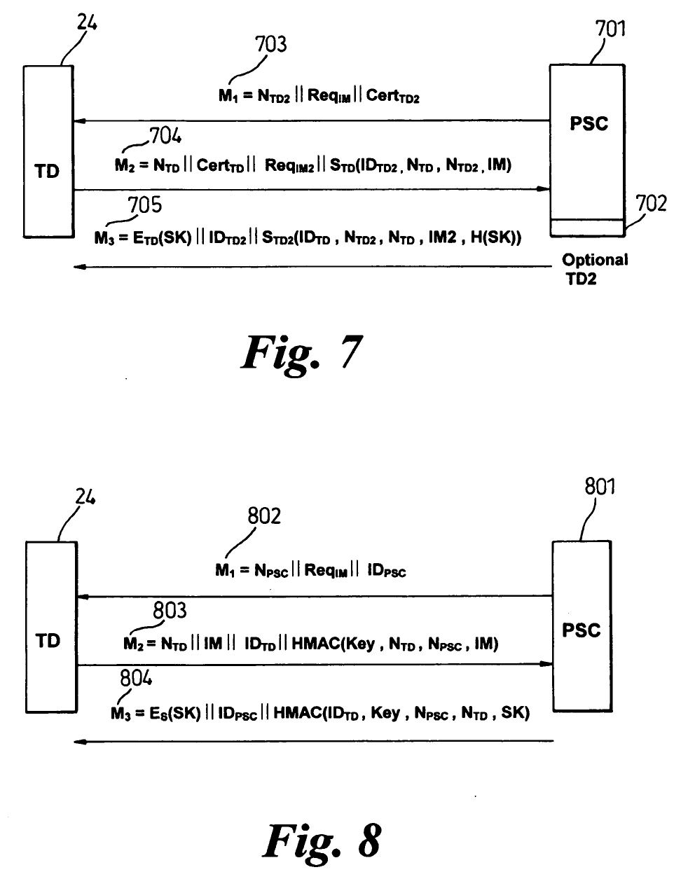

FIG. 7 illustrates a protocol used to allow the PSC 701 to challenge the TD 24 to obtain the TD's IM where the PSC 701 includes it's own TD 702.

A first message M1 703 is transmitted from the PSC 701 to the TD 24. The first message M1 703 includes the following data N_{TD2}, Req_{IM}, and Cert_{TD2}. In response to the first message M1 703 the TD 24 transmits a second message M2 704 to the PSC 701. The second message M2 704 includes the following data N_{TD}, Cert_{TD} Req_{IM2} and the following signed using the TD's private key—ID_{TD2} N_{TD} N_{TD2} IM. In response to the second message M2 704 the PSC 701 transmits a third message M3 705 to the TD 24. The third message M3 705 includes the following data ID_{TD2} and the following signed using the PSC's private key—ID_{TD} N_{TD2} N_{TD} IM2. Optionally message M3 705 can included SK that is encrypted using the TD public key and a hash of the SK that has been signed using the PSC's private key.

If the optional TD2 702 is in place, all the challenge processes would be done by TD2 702, in this case both parties can get/challenge each other's IM using the protocol in FIG. 7—whether or not to challenge TD2 702 depends on the application.

TD2 is another trusted device but it is optional whether or not to use it depend on the user and application.

One of the possible attacks of this model is, an attacker can pretend to be a TD if he can include the IM in message 2 (M₂). Also there is no control of whom can access services of the TD, anyone can access the services if they have a valid certificate (Public Key).

One solution of these problems is to have a trusted CA that only gives certificates to trusted devices (TD). And the users or challengers of any particular TD have to register their public keys with that particular TD in advance, so the TD can check whether the user is a registered/authorised user by comparing the certificate included in M₁.

Another solution to solve these problems is not to use private/public key pair, but to use symmetric cryptography with a different protocol, but the shared key must be agreed before the challenge. Once the PSC 801 and TD 24 installed the shared key, PSC 801 can challenge the TD 24 with the protocols shown in FIG. 8. The purpose of the challenge is to prove the identity of the PSC 801 (authenticate the user) to the TD 24 and to provide a trusted response on the IM.

A first message M1 802 is transmitted from the PSC 801 to the TD 24. The first message M1 802 includes the following data N_{PSC}, Req_{IM}, and ID_{PSC}. In response to the first message M1 802 the TD 24 transmits a second message M2 803 to the PSC 801. The second message M2 803 includes the following data N_{TD}, IM, ID_{TD} and the following signed using a Hash Message Authentication Code—Key N_{TD} N_{PSC} IM. In response to the second message M2 803 the PSC 801 transmits a third message M3 804 to the TD 24. The third message M3 804 includes the following data ID_{PSC} and the following signed using the Hash Message Authentication Code—ID_{TD} N_{PSC} Key N_{TD}. Optionally message M3 804 can included SK that is encrypted using encryption using the shared key and a hash of the SK that has been signed using the Hash Message Authentication Code.

Since TD 24 has its own private/public key pair, message 2 (M₂) can be replaced by with the following information N_{TD} Cert_{TD} S_{TD}(ID_{PSC}, N_{TD}, N_{PSC}, IM).

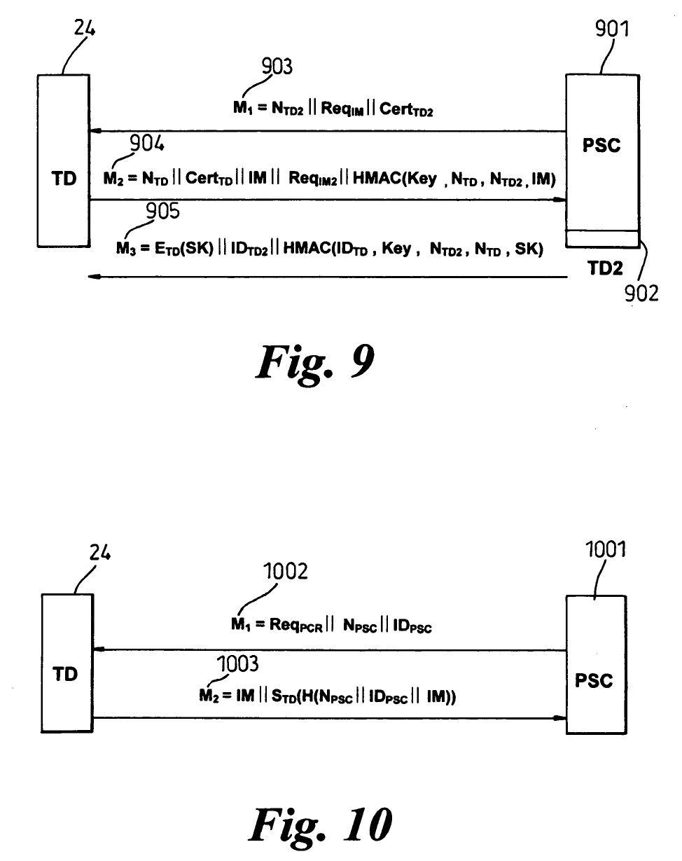

Similar to the asymmetric system, we can optionally install a trusted device TD2 902 in the PSC 901so that both parties can check each other's IM. But this time symmetric cryptography is used. The protocol for this embodiment is illustrated in FIG. 9.

A first message M1 903 is transmitted from the PSC 901 to the TD 24. The first message M1 903 includes the following data N_{TD2}, Req_{IM}, and Cert_{TD2}. In response to the first message M1 903 the TD 24 transmits a second message M2 904 to the PSC 901. The second message M2 904 includes the following data N_{TD} IM, Cert_{TD} Req_{IM2} and the following is signed using a Hash Message Authentication Code—Key N_{TD} N_{TD2} IM. In response to the second message M2 904 the PSC 901 transmits a third message M3 905 to the TD 24. The third message M3 905 includes the following data ID_{TD2} and the following signed using the Hash Message Authentication Code—ID_{TD} N_{TD2} Key N_{TD}. Optionally message M3 905 can included SK that is encrypted using encryption using the shared key and a hash of the SK that has been signed using the Hash Message Authentication Code.

The level of authentication needed depends on which services of the TD the user wants to use. Some services need mutual authentication (authenticate user and TD), e.g. use TD as part of a payment process. But some services only need unilateral authentication (only authenticate TD), e.g. use TD to send email. But before any user can use any services provided by the TD, the TD should have details about the users and set some rules stating which users can access what services.

Some users will not have any shared key with the TD, but they can still check the IM and see whether or not they want to use the services of the TD. Because the user doesn't have a shared key or registered public key with the TD, the TD cannot authenticate the user (PSC). But since these users will only be allowed to use limited services on the TD, a simple IM challenge protocol is sufficient. An example of a suitable protocol is illustrated in FIG. 10.

A first message M1 1002 is transmitted from the PSC 1001 to the TD 24. The first message M1 1002 includes the following data N_{PSC}, Req_{IM}, and ID_{PSC}. In response to the first message M1 1002 the TD 24 transmits a second message M2 1003 to the PSC 1001. The second message M2 1003 includes the following data IM and the following signed using the TD's private key and the Hash Message Authentication Code—ID_{PSC} N_{PSC} IM.

The protocols are very important in the integrity checking and the authentication processes. Without a good protocol, it is impossible to produce a trusted report on the integrity matrix.

1. A portable hand held computing apparatus comprising acquiring means for acquiring an first integrity metric of a first computer apparatus for determining if the first computer apparatus is a trusted entity, the acquiring means being responsive to input means for initiating the acquisition; and presentation means for presenting to a user an indication that the first computer apparatus is a trusted device.

2. A portable handheld computing apparatus according to claim 1, further comprising a trusted device being arranged to acquire an second integrity metric for the portable handheld computing apparatus to allow determination as to whether the portable handheld computing apparatus is a trusted entity; and communication means for communicating the second integrity metric to the first computer apparatus to allow mutual determination as to the trusted state of the portable handheld computer apparatus and first computer apparatus.

3. A portable handheld computing apparatus according to claim 1, further comprising cryptographic means arranged to provide authentication data to the first computer apparatus.

4. A portable handheld computing apparatus according to any preceding claim, wherein the computing apparatus is a personal digitial assitant.

5. A portable handheld computing apparatus according to any of claims 1 to 4, wherein the computing apparatus is a radiotelephone.

6. A portable handheld computing apparatus according to any of claims 1 to 4, wherein the computing apparatus is a smart card.

7. A portable handheld computing apparatus according to any of claims 1 to 4, wherein the computing apparatus is a biometrics reader.
